(19) United States
(12) Patent Application Publication
(10) Pub. No.: US 2020/0200649 A1
(43) Pub. Date: Jun. 25, 2020

(54) REAL-TIME CARBON FOOTPRINT DETERMINATION FOR A DRIVER OF A VEHICLE

(71) Applicant: 2162256 ALBERTA LTD., Edmonton (CA)

(72) Inventors: Ayman Ammoura, Edmonton (CA); David Mulcair, Edmonton (CA)

(21) Appl. No.: 16/721,751

(22) Filed: Dec. 19, 2019

Related U.S. Application Data
(60) Provisional application No. 62/783,881, filed on Dec. 21, 2018.

(51) Int. Cl. G01M 15/10; B60W 40/09; B60W 50/08; G08G 1/00

(52) U.S. Cl. CPC G01M 15/102; G08G 1/22; B60W 50/082; B60W 40/09

(57) ABSTRACT

Systems and methods that provide for fuel usage monitoring, carbon footprint determination, and solutions for reducing vehicular carbon footprint are disclosed herein. One embodiment of a system includes a processor and memory, the processor being configured to execute instructions stored in memory to perform a method of receiving a selection of a specific vehicle from a number of vehicles in a fleet for use by a driver; receiving via a computer network, a number of vehicle performance metrics for a trip performed by the driver in the specific vehicle; and determining a carbon footprint value for the driver performing the trip based at least on chemical composition of a fuel type, and a fuel consumption performance metric for the specific vehicle. Also, the system provides a method of selecting, one or more actions to reduce the carbon footprint value of the driver, and selectively communicating the selected actions to a driver's computing device.

### CROSS REFERENCE TO RELATED APPLICATIONS

The present application claims the priority benefit of U.S. provisional patent application No. 62/783,881 filed Dec. 21, 2018 and entitled “REAL-TIME CARBON FOOTPRINT DETERMINATION”, the disclosure of which is incorporated by reference herein in its entirety.

### FIELD OF THE INVENTION

The present technology pertains to vehicles, and more particularly, but not by way of limitation, to systems and methods that provide for fuel usage monitoring, carbon footprint determination, and solutions for reducing vehicular carbon footprint.

### BACKGROUND

As generally understood by persons of ordinary skill in the art, a carbon footprint is a total amount of greenhouse gases produced, usually expressed in equivalent tons of carbon dioxide (CO₂). While numerous greenhouse gases may be produced from a specific activity, they are converted into an amount of CO₂ that would cause the same effects on global warming, which is called an equivalent amount of CO₂. Thus, a carbon footprint is expressed in tons of CO₂ even though it's determined based on generation of various greenhouse gases.

A carbon footprint is a powerful tool to understanding the impact of human behavior on global warning. Thus, being able to determine and calculate the carbon footprint generated from an activity in substantial real-time for each person across a fleet of vehicles is a powerful mechanism for allowing a human to see the impact of their activities and take corrective action sooner rather than later.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

A system of one or more computers can be configured to perform particular operations or actions by virtue of having software, firmware, hardware, or a combination of them installed on the system that in operation causes the system to perform the actions. One or more computer programs can be configured to perform particular operations or actions by virtue of including instructions that, when executed by data processing apparatus, cause the apparatus to perform the actions. In some embodiments, a method performed by the system includes receiving a selection of a specific vehicle from multiple vehicles in a fleet for use by a driver. Also included is receiving via a computer network, one or more vehicle performance metrics for a trip performed by the driver in the specific vehicle. The method further includes determining a carbon footprint value for the driver performing the trip based at least on a chemical composition of a fuel type, and a fuel consumption performance metric for the specific vehicle.

In some embodiments, the method also includes selecting, from multiple footprint reduction actions, at least one action to reduce the carbon footprint value of the driver, and selectively communicating one or more of the actions to a computing device operated by the driver.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is a schematic diagram of an example system constructed in accordance with the present disclosure.

FIG. 2 is a flowchart of an example method of the present disclosure.

FIG. 3 is a flowchart of an example method of the present disclosure.

FIG. 4 is a flowchart of another example method of the present disclosure.

FIG. 5 is a diagrammatic representation of an example machine in the form of a computer system.

FIG. 6 is an exemplary table according to embodiments of the present disclosure.

### DETAILED DESCRIPTION

The following detailed description includes references to the accompanying drawings, which form a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense.

The present disclosure is directed to systems and methods that provide fuel usage monitoring, carbon footprint determination, and solutions for reducing vehicular carbon footprint generated by drivers of vehicles.

It will be understood that while some embodiments disclosed herein refer to applications of the present technology for use in land-based vehicles of any type and size, such as automobiles using internal combustion engines and a carbon fuel source, the systems and methods herein disclosed are not so limited, and apply generally to all possible vehicles using combustion engines. By non-limiting example, land-based vehicles can include: a sedan, pickup truck, motorcycle, moped, van, tractor, recreational vehicle, 18-wheeled vehicle, and bus. The real-time carbon footprint determination methods and systems are applicable to other types of vehicles or machinery such as trains, industrial machinery, water-based vehicles (e.g. boats), and air-based vehicles (e.g. airplanes and drones) of various types and sizes that use combustion engines.

When a vehicle is in operation, an engine combusts a fuel, such as a hydrocarbon, in the presence of an oxidant, such as oxygen, thereby transforming chemical potential energy into kinetic energy. The combustion process emits carbon dioxide (CO₂), along with other gases and chemical byproducts. The quantity of CO₂ and other greenhouse gases emitted by a combustion engine during operation varies with the chemical composition of the fuel type, the quantity of fuel combusted, and the engine combustion efficiency.

Regarding fuel type, when combusted, hydrocarbon fuels for example, emit varying amounts of CO₂ depending upon several properties, including the molecular length and configuration of the fuel's hydrocarbon chains. Regarding fuel quantity, fuel consumption is determined by the quantity of fuel combusted by a combustion engine in a vehicle traveling a particular distance at a particular speed. Larger quantities of fully combusted fuels, for example, will emit larger quantities of CO₂. Larger displacement engines and more frequent engine combustion cycles, expressed in Revolutions Per Minute (RPM), generally increase engine fuel consumption and CO₂ emissions. Long engine idling periods also consumes fuel and emits CO₂. Engine combustion efficiency depends upon a number of other criteria, including engine type, combustion chamber design, intake air quantity, and ambient air temperature, for example. Vehicle operating conditions can also change vehicle and engine loads causing variable fuel consumption. Exemplary load conditions include driving behavior, tire pressure, and engine load conditions introduced by other vehicle components such as engine-driven air conditioner compressors.

The present disclosure provides systems and methods for determining a carbon footprint based on fuel consumption of a particular fuel type in real-time during operation of a vehicle. Various embodiments assess fuel consumption using engine and vehicle performance metrics. Driving behavior, in particular, may dramatically alter fuel consumption and carbon emission levels. Driving behaviors that typically increase a vehicle's carbon footprint include long periods of engine idling, running an engine at high RPM, frequent hard braking activity, and rapid acceleration and deceleration. Thus, a particular vehicle can generate different carbon footprints based on different driving behaviors. Further, different environments where vehicles are driven also impact carbon footprint. For example, a vehicle driven in a hilly area or in a city landscape with lots of traffic lights will generate a different carbon footprint than it would if being driven in a relatively flat terrain without much stopping and starting behavior from traffic lights and stop signs, even if the vehicle travels the same distance or is operated for the same amount of time.

In various embodiments, the systems and methods described herein provide use of vehicles to authorized personnel in a fleet use scenario. In embodiments where authorization is required, a driver authorization evaluation is performed by the fleet management system evaluating driver authorization to operate a specific vehicle based on data identifying a specific driver. The authorization evaluation is performed prior to vehicle selection by the driver or fleet operator. For example, one or more employees of a company can be provided access only to certain vehicles of that company's fleet based on authorization by a fleet operator, or because of a vehicle class restriction on the driver's license. As a non-limiting example, if an employee is not authorized to operate a large commercial vehicle, embodiments of the systems and methods herein prevent the employee from access to such a vehicle. The present disclosure is directed to a fleet operator that has a plurality of vehicles within its fleet. A plurality of human drivers are authorized to operate one or more of the plurality of vehicles within the fleet. A fleet operator may utilize a fleet management software application to track operations and carbon footprint of each of the vehicles within its fleet, and operations and carbon footprint of each of the authorized drivers.

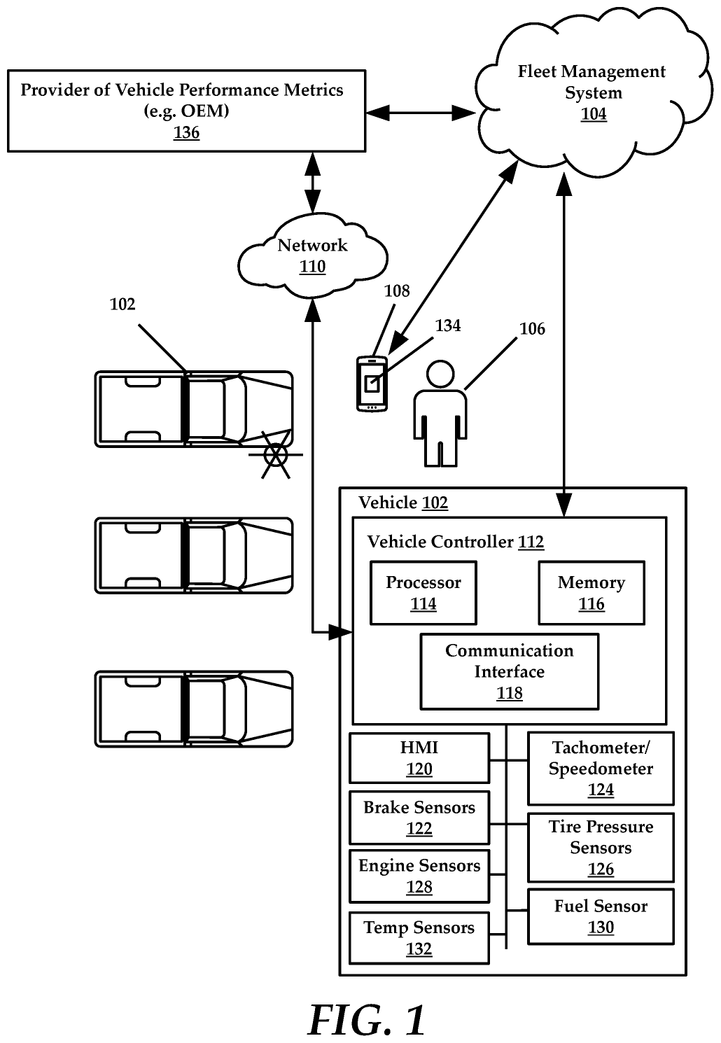

FIG. 1 is a schematic representation of an example environment in which the present disclosure is practiced. In one embodiment, the environment includes a vehicle 102, a fleet management system 104, a user 106, a user computing device 108, and a network 110. As used herein, a user computing device 108 can comprise any of a smartphone, smart-watch, tablet, laptop, desktop computer, netbook, embedded computers, or any other such similar device. In some embodiments, the user 106 is an authorized driver of a selected vehicle 102 in a fleet of vehicles. In various embodiments, the user 106 is a fleet operator. The selected vehicle may be chosen by the driver directly or by a fleet operator on behalf of the driver. A plurality of other vehicles 102 for which the driver has authorization, may be available for selection as well.

In general, each of the components of the environment can communicate over the network 110. The network 110 can include any one or a combination of multiple different types of networks, such as cable networks, the Internet, cellular networks, wireless networks, and other private and/or public networks. In some instances, the network 110 can include cellular, Wi-Fi, or Wi-Fi direct. In other embodiments, components of the environment can communicate using short-range wireless protocols such as Bluetooth, near-field, infrared, and the like.

In some embodiments, the vehicle 102 comprises a vehicle controller 112 that comprises a processor 114, memory 116, and a communication interface 118. The vehicle 102 also can include a human machine interface (HMI) 120. The vehicle 102 includes performance sensors that can comprise, without limitation, one or more brake sensors 122, a tachometer and speedometer 124 to measure RPM and vehicle speed, respectively, one or more tire pressure sensors 126, one or more engine sensors 128, a fuel sensor 130, and one or more temperature sensors (e.g. ambient air, coolant) 132. The vehicle controller 112 can collect and transmit data collected by the sensors to the fleet management system 104 directly. In some embodiments, the sensor data is communicated to the fleet management system 104 directly and substantially in real-time. In various embodiments, the sensor data is supplied indirectly to the fleet management system 104 via a provider of vehicle performance metrics 136, such as an Original Equipment Manufacturer (OEM).

In various embodiments, the fleet management system 104, vehicle controller 112, and user computing device 108 coordinate data communications to provide automated carbon footprint monitoring and control. In some embodiments, the user computing device 108 implements an application 134 that allows the user 106 to interact with the fleet management system 104. In various embodiments, the fleet management system 104 can be implemented as a cloud-based service, or alternatively in a physical or virtual server configuration. A data storage, configured as a database, can be connected to the fleet management system 104 for storage and retrieval of vehicle, driver, and carbon footprint related data.

In various embodiments, vehicle performance metrics are measured by one or more sensors onboard the vehicle 102 as shown by non-limiting example in FIG. 1, elements 122 through 130. In some embodiments, the sensor(s) measure performance of vehicle component(s) in substantially real-time, and also transmit collected data to the fleet management system 104 for the purpose of determining a carbon footprint substantially in real-time. In various embodiments, and by non-limiting example, vehicle performance metrics include engine idling time, RPM measurement, acceleration rate, deceleration rate, a fuel type, fuel consumption measurement, tire pressure measurement, outdoor air temperature, a time identifier, a period identifier. Additional vehicle and component identifying and classification data can accompany data communications of vehicle performance metrics. The identifying and classification data can include a vehicle identifier, a vehicle manufacturer, a vehicle classification, a vehicle make, a vehicle model, a vehicle model year, a vehicle engine type, and an engine displacement. The data is communicated either directly or indirectly via an onboard computer to a fleet management system 104. The fleet management software application may be a cloud software application that is in contact with a user computing device 134 of the driver or the fleet operator.

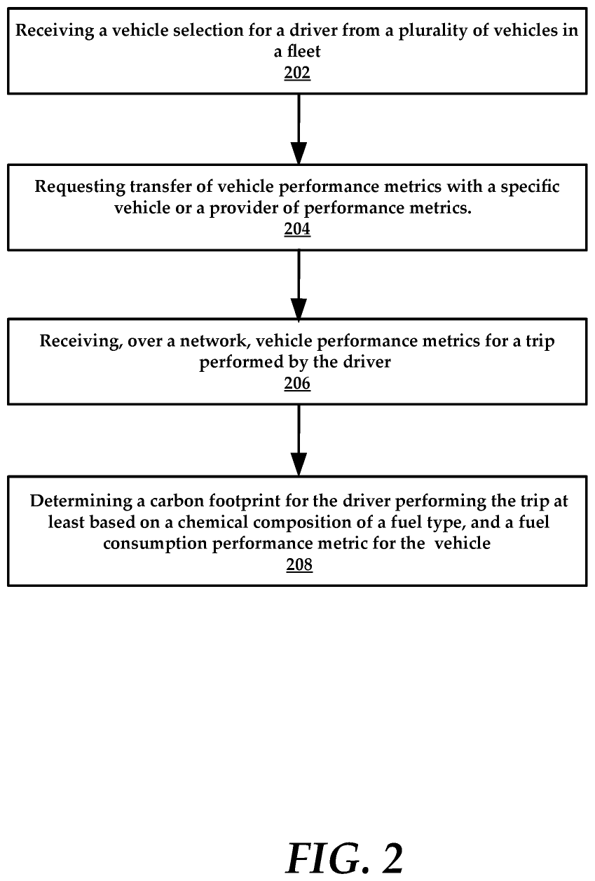

FIG. 2 is a flowchart of a method of various embodiments of the present disclosure. The method is performed from the perspective of the fleet management system 104. In one embodiment, the method includes a step 202 of receiving a vehicle selection for a driver from a plurality of vehicles 102 in a fleet. In various embodiments, the vehicle selection is initiated by a user 106. The user 106 may be a fleet operator initiating the selection on a user computing device 108 connected via an application 134 connected to a fleet management software application on the fleet management system 104. In various embodiments, a driver may initiate the vehicle selection on a user computing device 108, and the selection is transmitted to the fleet management software application on the fleet management system 104.

A Step 204 of the method comprises requesting a data transfer of the vehicle performance metrics for a specific vehicle 102. In various embodiments, and by non-limiting example, a provider of vehicle performance metrics 136 is an Original Equipment Manufacturer (OEM) that monitors and receives sensor data from sensors regularly installed on the selected vehicle 102. The vehicle performance metrics data is indirectly received via the provider 136. As part of the request for data transfer, the identity of the specific vehicle 102 from which to obtain the performance metric data is identified by transmission of a vehicle identifier, such as a vehicle identification number (VIN) from the fleet management system 104 to the vehicle performance metrics provider 136. In various other embodiments, the fleet management system 104 can issue a similar request directly to the vehicle controller 112 on the selected vehicle 102 to initiate transfer of the performance metrics recorded from vehicle sensors.

A Step 206 of the method further comprises receiving vehicle performance metrics by the fleet management system 104 either directly from the vehicle 102 or indirectly from a provider of vehicle performance metrics 136. In some embodiments, the vehicle performance metrics data is sensed by the vehicle 102 and transmitted in real-time. In various other embodiments, vehicle performance metrics data is sensed by the vehicle 102 and recorded and transmitted at a later time to the fleet management system 104.

In a step 208 of the method, a carbon footprint is determined for a specific driver operating a specific vehicle during a specific trip. The method uses the chemical composition of the fuel in addition to the fuel consumption by the vehicle to calculate the carbon footprint.

In various embodiments, a computing device onboard the vehicle, such as a vehicle controller 112, collects data from a plurality of sensors, of the vehicle 102, in either a wired or wireless manner. The vehicle controller 112 can then wirelessly transmit, via a communication interface 118, the collected data directly to the fleet management software application on the fleet management system 104. The fleet management software application uses the collected data to determine a carbon footprint generated by the vehicle 102 while operated by the driver. In some embodiments, the cloud software application can wirelessly transmit the carbon footprint determination to the vehicle's onboard computer, for display on a vehicle's Human-Machine Interface (HMI) 120, and/or to a user computing device 108 of a driver of the vehicle 102.

In other embodiments, a computing device onboard the vehicle 102 may collect data from a plurality of sensors of the vehicle 102, either in a wired or wireless manner. The onboard computing device may then use the data to determine a carbon footprint. The generated carbon footprint can be displayed on an HMI 120 within the vehicle 102, on a display of a user computing device 108 of a driver of the vehicle 102, and/or transmitted wirelessly to a cloud software application in communication with the vehicle's onboard computer via a communication interface 118.

While a vehicle 102 is in operation, or shortly after it ceases operation, data from the onboard sensors and/or the determined carbon footprint for a vehicle session may be transmitted to a computing device 108 of the fleet operator via the fleet management system 104. In this way, the fleet operator can view a carbon footprint generated by a particular vehicle that was operated by a particular driver during a vehicle session or trip. The fleet operator can also view a carbon footprint generated by a particular driver across multiple vehicles in the fleet. This information can be stored within a data structure (such as a database) of a fleet management software application, and viewed by a fleet operator on a computing device display. Over a data collection period, a “carbon profile” can be determined for a human driver that provides a tracking of variations in carbon footprint for the driver, irrespective of the vehicle 102 driven.

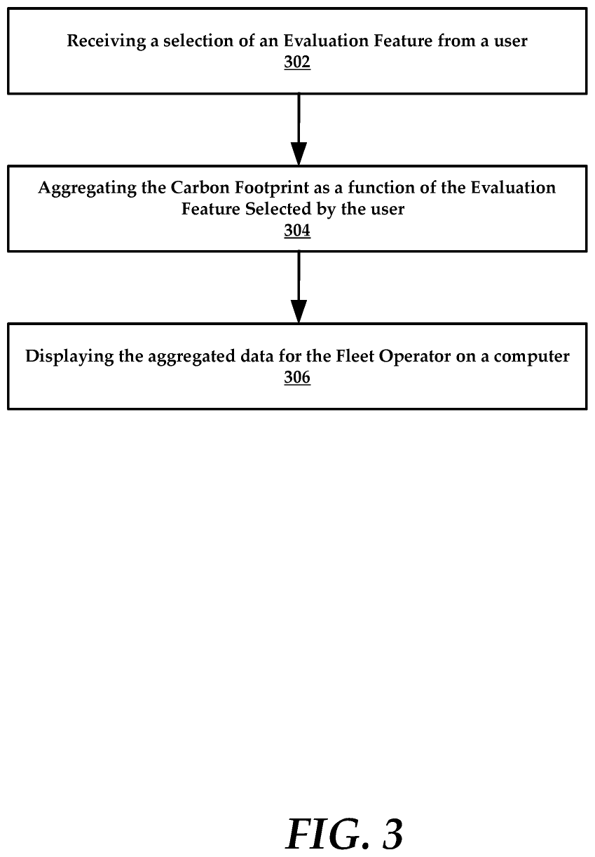

Over a data collection period, the fleet management software application can determine an aggregate carbon footprint generated by a particular vehicle 102 based on measured and calculated criteria. FIG. 3 is a flowchart of a method for some embodiments of the present disclosure. The method is performed from the perspective of the fleet management system 104. In various embodiments, the method includes a step 302, wherein the fleet management system 104 receives a selection of an evaluation feature to be analyzed as a function of aggregated carbon footprint calculations. Non-limiting examples of evaluation features comprise vehicle manufacturer, one or more fleet vehicles, vehicle classification, vehicle make, vehicle model, vehicle production year, engine type, engine displacement, fuel type, vehicle driver, authorized driver group, and driving period. A step 304 aggregates the carbon footprint as a function of the evaluation feature selected by the user.

Aggregations of carbon footprint can also be generated for all vehicles as a function of an evaluation feature. Non-limiting exemplary aggregated data relationships for a vehicle-based evaluation feature include an aggregate footprint generated by a vehicle 102 over a certain period of time, regardless of human driver of that vehicle 102; an aggregate footprint generated by all vehicles of a certain manufacturer; an aggregate footprint generated by all vehicles of a certain class of vehicle; an aggregate footprint generated by all vehicles of a certain make, model, or model year; an aggregate footprint generated by all vehicles of certain engine type and displacement (e.g., 2.0 Liter 4-cyclinder, 3.0 liter 6-cylinder); an aggregate footprint generated by all vehicles utilizing a certain type of fuel (e.g. diesel, unleaded);. As would be understood by persons of ordinary skill in the art, an aggregate footprint can be determined based on any relevant metric.

In a non-limiting example, the fleet management software application can determine an aggregate carbon footprint generated by a particular driver, regardless of specific vehicle 102 driven. Based on the aggregate carbon footprint for a driver, a metric such as a carbon profile can be generated and updated in substantially real-time for each authorized driver of the fleet's vehicles. This metric can be transmitted to a user computing device 108 of the driver, transmitted to a display of a HMI 120 onboard a vehicle 102, and/or viewed by a fleet operator via an application 134 that interfaces with the fleet management system.

Aggregations of carbon footprint can also be generated for all drivers as a function of an evaluation feature. Without limitation, examples include an aggregate footprint generated for all drivers of a particular class of vehicle; an aggregate footprint generated by all drivers of vehicles of a certain make or model, etc. As would be understood by persons of ordinary skill in the art, any number of criteria can be used to aggregate carbon footprint generation data for a driver across an entire fleet of vehicles, or for a vehicle 102 across multiple drivers.

A step 306 displaying the aggregated data on a computer allows the fleet operator, or other user 106 to view reports and statistics regarding carbon footprint generated by drivers and vehicles 102. The displayed data can assist with optimizing usage of the fleet vehicles 102 for efficiency control, expense control, and accountability for the types of vehicle 102 that a driver chooses to operate within the fleet. In this way, efficiencies within the fleet as a whole can be optimized.

In one non-limiting example, a fleet operator may see from the fleet management software application that two vehicles 102 in the fleet are operated exclusively during daytime hours and two separate vehicles 102 in the fleet are operated exclusively during night hours, and that this pattern of usage has been consistent for a month. The fleet operator can then determine that four vehicles 102 may be unnecessary and the tasks can be accomplished by simply having two vehicles total, with each one operating during daytime hours as well as night hours. In this way, overall fleet efficiency can be optimized.

In some embodiments, a fleet operator can view a carbon footprint generated and see whether it is improving or getting worse over time. A carbon footprint profile can be generated for a specific driver, regardless of vehicle 102 driven, so that a driver's carbon footprint over time can be tracked. Further, a group of drivers' carbon footprint can be analyzed over time to view carbon usage trends for the fleet as a whole and any subset of the fleet.

In other embodiments, the fleet management system 104 can generate and compare carbon footprint determinations for each driver of a particular vehicle 102. In a non-limiting example, the fleet management system 104 may determine that Driver A generated 5 kg of carbon per 100 kilometers driven, but Driver B only generated 4 kg of carbon per 100 kilometers driven on the same car. In this way, it can be determined that Driver A is operating the vehicle 102 in an inefficient manner and recommendations may be provided to Driver A to reduce carbon usage on future trips.

In several embodiments, carbon usage for Driver A across all vehicles 102 driven in the fleet over a specific period can be aggregated by the fleet management software. In addition, carbon usage for Driver B across all vehicles 102 driven in the fleet over a specific period are also aggregated. Driver A's carbon usage across a plurality of vehicles can be compared to Driver B's carbon usage across a plurality of vehicles to determine specific driver performance regardless of vehicle 102.

Thus, the fleet management software may determine total carbon usage for a vehicle trip, and may show how the vehicle 102 was operated to generate the particular carbon usage, including identification of the specific driver responsible for the carbon usage.

In various embodiments, a driver may have a choice of which vehicle 102 within the fleet to utilize for a particular trip. The fleet management software application can identify and track the specific vehicle 102 the driver selected based upon a vehicle selection input of the user entered into the software application 134 on the user computing device 108 that communicates with the fleet management system 104. In various embodiments, the fleet management software application can track various specific performance metrics of the vehicle 102 during vehicle 102 operation by the driver (such as engine idling, RPM, acceleration/deceleration times, etc.) based on information received from the vehicle sensor(s). Combining this data allows the fleet management software application to generate a carbon footprint for a specific driver for a specific vehicle 102, in substantially real-time.

In an exemplary embodiment, a Total Trip Speed Gain (TTSG) can be determined for a given trip, as defined by the formula:

$$TTSG = {\sum }_{i = 0}^{k} \frac{\vert {s}_{i + 1} - {s}_{i} \vert + ( {s}_{i + 1} - {s}_{i} )}{2} ,$$

where k is the number of time slices (data polling resolution), and si is the speed of the vehicle at time slice tᵢ. The calculated TTSG value can be used to characterize traffic congestion during a particular trip undertaken by a driver of a vehicle. For example, if a vehicle has multiple start and stops incidents in a short period of time, due to traffic congestion, then the fuel usage (and thus carbon footprint) will be higher. However, that is not necessarily the fault of the driver and something the driver may be able to control or change. As such, traffic congestion is an important factor to take into consideration when determining a carbon footprint for a driver. A TTSG averaged throughout a trip will create a speed gain index.

In one example, when a vehicle accelerates from a parked position to a speed of 50 mph, then that is a 50 mph increase for (sᵢ₊₁−sᵢ). Then the driver may slow down to 10 mph due to traffic, and then go back to 50 mph. Thus, another increase of 40 mph is experienced, which is a cumulative gain of 90 thus far for the trip.

Further, a gyroscope from either a user mobile device, or from a sensor in a vehicle, is used to obtain the g-forces generated at any particular time during a trip. The sum of the g-forces generated in a trip can be averaged per distance driven to create a g-force index. In one example, the g-force generated by a Toyota Corolla is always bigger than a commercial truck such as a dump truck or 18-wheeler truck, since the Toyota Corolla can accelerate much faster.

The TTSG and g-force index together are utilized to represent a driver carbon classification in the form of a tuple: (CO2 generated, TTSG, g-force index). While the CO2 generated is based on vehicle metrics, the TTSG and g-force index for a driver take into account specifics of driver behavior during a trip. Thus, a driver score is based on type of vehicle driven. Further, the driver score and classification may influence a recommendation to the driver as to which vehicle to choose from the fleet for a future trip.

In further embodiments, every vehicle in a fleet of vehicles will have its own baseline amount of CO2 generated. This baseline amount of CO2 generation is based on data collected from one or more drivers over a predetermined time period, such as 30 days. Subsequent trips/drivers can then be evaluated based on this baseline. Additionally, the baseline can be assessed and updated periodically for each vehicle, especially if no other drivers are assigned to the vehicle for a certain time period. As one example, a responsible safety trainer driver can take the vehicle out for a drive as soon as it is rolled into a fleet to create a first baseline. These drivers will operate the vehicle with low acceleration and low speed build up index. Alternatively, a baseline can be generated for a vehicle, regardless of which fleet that vehicle is present in. This data can be shared on the platform for other vehicles of similar manufacture year, make, model, trim, and/or equipment.

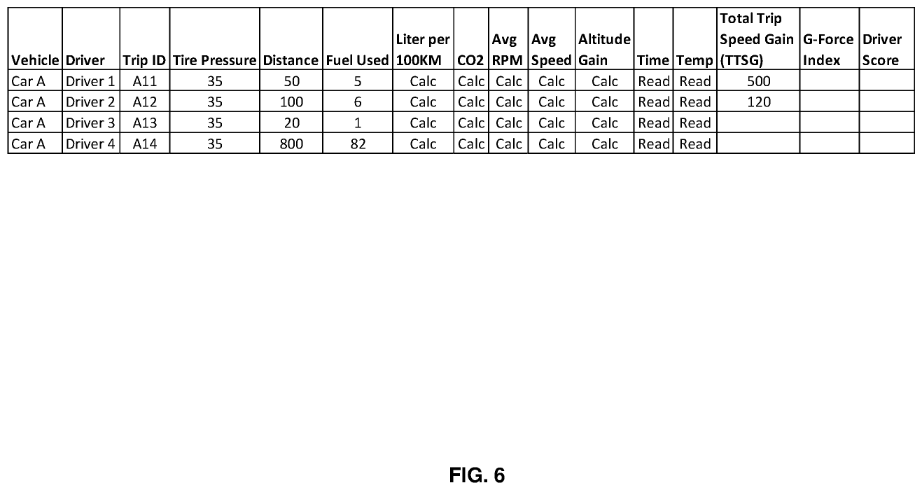

FIG. 6 depicts an exemplary table showing metrics for a particular vehicle “Car A”. Based on a known tire pressure from the vehicle, distance traveled by the vehicle during a trip, outside ambient air temperature, time, fuel used during the trip, and/or altitude, a number of factors can be determined. For example, an amount of fuel consumed per distance can be calculated, as well as an equivalent amount of CO2 generated during the trip, average RPM, average speed, and altitude gain. From one or more of these factors, TTSG can be generated, along with the g-force index to determine a driver score and driver classification for the trip.

Each driver of Car A can be scored by comparison to the baseline for the vehicle. If there are other vehicles in the fleet of the same type as Car A, then the baseline exists. If there are no other vehicles of the same type as Car A in the fleet, then a baseline can be generated, as discussed herein. Further, a baseline for the same vehicle type as Car A from a different fleet on the platform can be used.

In this way, a carbon profile of a vehicle can be generated, as well as a carbon profile for a specific driver. Thus, a driver of a vehicle whose route is primarily during heavy traffic hours or in downtown is not unfairly penalized for having a higher carbon footprint score compared to a driver whose route is during light traffic hours or in a more rural area. Further, a carbon profile of a driver is generated based at least in part on driver behavior, regardless of which vehicle in a fleet is driven by the driver for a particular trip.

As shown in FIG. 3, a step 308 in the method performed by the fleet management software may include monitoring aggregated carbon footprint values, and comparing the values to a predetermined threshold value for an acceptable carbon footprint. The threshold for an acceptable carbon footprint is based on factors such as outside temperature, tire pressure, vehicle make, etc.

If a driver exceeds the threshold carbon footprint for a particular trip, then the fleet operator can determine that the driver is not operating the vehicle 102 efficiently. As shown in FIG. 3, step 310, a warning may be presented to the driver via the vehicle HMI 120, or via the driver's user computing device 108 to perform one or more corrective actions to reduce the carbon footprint.

By way of non-limiting example, carbon footprint reduction actions may comprise adjusting vehicle tire pressure, modifying driver acceleration rates, modifying driver deceleration rates, modifying vehicle idle time, and modifying vehicle choice. In some embodiments, a step 310 may include transmitting a notification of the carbon reduction action to the driver and/or the fleet operator via a user computing device 108.

The fleet management software enables comparisons of carbon footprint to generate recommendations. In one non-limiting example, a human driver may have a choice of vehicles from the fleet. The fleet management software application may learn that the human driver often chooses to operate vehicles that generates higher carbon footprints, while other vehicles that generates lower carbon footprints are not chosen despite the suitability to the purpose of the trip. As such, the fleet management software application 132 may transmit a message to the fleet operator to recommend to the human driver that he/she select a different vehicle 102 for the trip.

In various embodiments, the fleet management software application may be in communication with a user computing device 108 of the human driver. A recommendation to select a different vehicle 102 for the trip can be displayed on the user computing device 108 of the driver. As such, the driver is encouraged to select a different vehicle 102 that is still suitable for the trip purpose, but reduces the driver's carbon footprint generation, as well as the carbon footprint generation for the entire fleet. As would be understood by persons of ordinary skill in the art, other types of recommendations can be provided to the driver to reduce the carbon footprint.

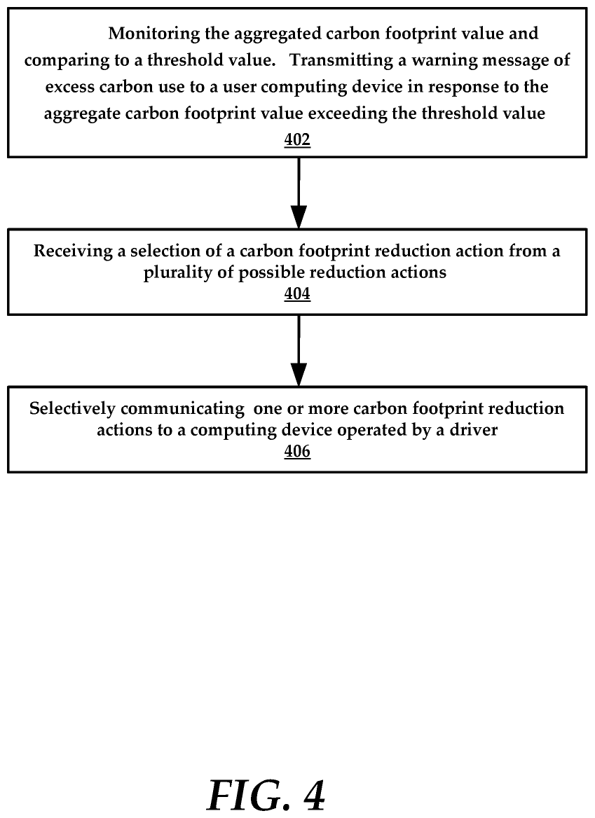

In some embodiments, as shown in FIG. 4, a step 402 provides for a user 106, such as a fleet operator, to select at least one carbon footprint reduction action from a number of possible reduction actions even if no warning message has been issued. In accordance with step 404, one or more of the recommended footprint reduction actions are selectively communicated to the driver on a user computing device 108.

In various embodiments, the fleet management system may include a method of presenting a graphical user interface (GUI) on a human machine interface (HMI) within the vehicle 102 or on another user computing device 108. The GUI facilitates interaction between the driver and the fleet management system. By non-limiting example, a GUI can facilitate receiving and viewing data such as the carbon footprint value, the aggregate carbon footprint value, a warning message that a threshold carbon footprint value has been exceeded, and one or more carbon footprint reduction actions.

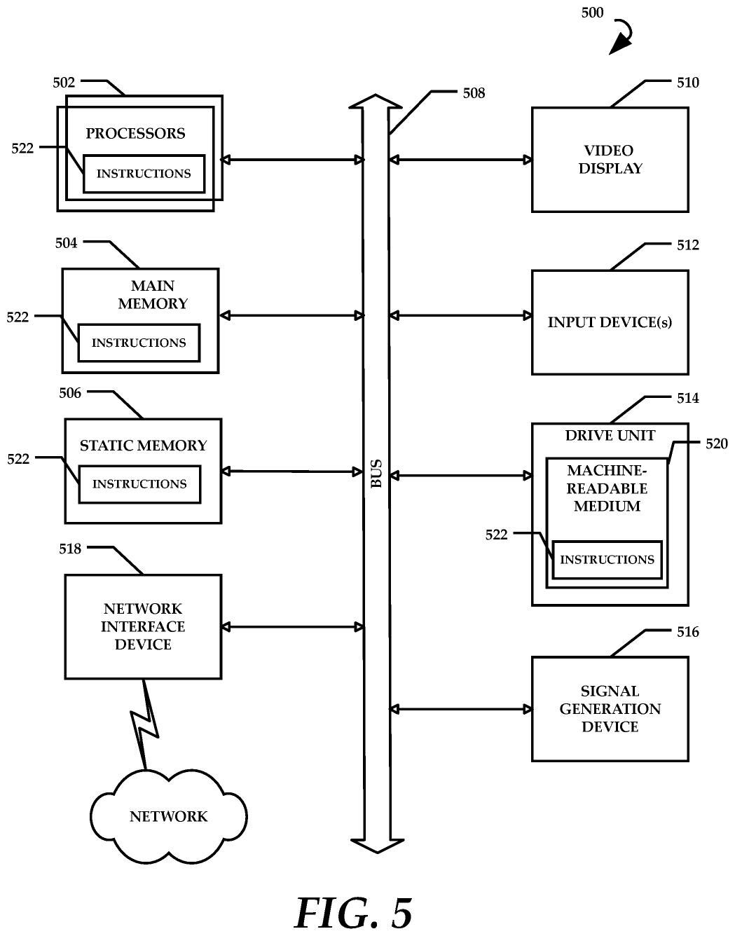

FIG. 5 is a representation of an example machine in the form of a computer system 500, within which a set of instructions cause the machine to perform any one or more of the disclosed methods. In various example embodiments, the machine operates as a standalone device or it is connected (e.g., networked) to other machines. In a network, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor or multiple processor(s) 502 (e.g., a central processing unit (CPU), a graphics processing unit (GPU), or both), and a main memory 504 and static memory 506, which communicate with each other via a bus 508. The computer system 500 may further include a video display 510 (e.g., a liquid crystal display (LCD)). The computer system 500 may also include an alpha-numeric input device(s) 512 (e.g., a keyboard), a cursor control device (e.g., a mouse), a voice recognition or biometric verification unit (not shown), a drive unit 514 (also referred to as disk drive unit), a signal generation device 516 (e.g., a speaker), and a network interface device 518. The computer system 500 may further include a data encryption module (not shown) to encrypt data.

The disk drive unit 514 includes a computer or machine-readable medium 520 on which is stored one or more sets of instructions and data structures (e.g., instructions 522) embodying or utilizing any one or more of the methodologies or functions described herein. The instructions 522 may also reside, completely or at least partially, within the main memory 504 and/or within the processor(s) 502 during execution thereof by the computer system 500. The main memory 504 and the processor(s) 502 may also constitute machine-readable media.

The instructions 522 may further be transmitted or received over a network via the network interface device 518 utilizing any one of a number of well-known transfer protocols (e.g., Hyper Text Transfer Protocol (HTTP)). While the machine-readable medium 520 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope of the present technology. Exemplary embodiments were chosen and described in order to best explain the principles of the present technology and its practical application, and to enable others of ordinary skill in the art to understand the present technology for various embodiments with various modifications as are suited to the particular use contemplated.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein is for the purpose of describing particular embodiments only and is not intended to be necessarily limiting of the disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Unless otherwise defined, all terms (including technical and scientific terms) used herein have the same meaning as commonly understood by one of ordinary skill in the art to which this disclosure belongs. The terms, such as those defined in commonly used dictionaries, should be interpreted as having a meaning that is consistent with their meaning in the context of the relevant art and should not be interpreted in an idealized and/or overly formal sense unless expressly so defined herein.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In this description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. The appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wired or wireless means) information signals (whether containing data information or non-data/control information) to the second entity regardless of the type (analog or digital) of those signals. It is further noted that various figures (including component diagrams) shown and discussed herein are for illustrative purpose only, and are not drawn to scale. While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A method, comprising:
receiving a selection of a specific vehicle from a plurality of vehicles in a fleet for use by a driver;
receiving, via a computer network, at least one vehicle performance metric for a trip performed by the driver in the specific vehicle; and
determining a carbon footprint value for the driver performing the trip based at least on chemical composition of a fuel type, and a fuel consumption performance metric for the specific vehicle.

2. The method according to claim 1, wherein the computer network comprises at least one user computing device interactively coupled to a fleet management system, the fleet management system communicatively coupled to a provider of vehicle performance metrics.

3. The method according to claim 2, wherein the provider of vehicle performance metrics receives the metrics substantially in real-time from a plurality of sensors and communicates the metrics to the fleet management system substantially in real-time.

4. The method according to claim 1, further comprising:
selecting, from a plurality of footprint reduction actions, at least one action to reduce the carbon footprint value of the driver; and
selectively communicating the at least one action to a user computing device operated by the driver.

5. The method according to claim 4, further comprising:
selecting at least one evaluation feature from a plurality of evaluation features;
generating an aggregate carbon footprint value by aggregating a plurality of the carbon footprint values from a plurality of trips as a function of the selected evaluation feature;
communicating the aggregate carbon footprint value to the fleet management system;
monitoring, by the fleet management system, the aggregate carbon footprint value in comparison to a threshold value; and
communicating a warning message of excess carbon usage to the user computing device in response to the aggregate carbon footprint value exceeding the threshold value.

6. The method according to claim 5, further comprising:
generating a compilation of a plurality of aggregate carbon footprint values;
transmitting the compilation to the fleet management system for performing resource optimization of fleet vehicles and drivers.

7. The method according to claim 6, further comprising a method of:
presenting a graphical user interface on a human machine interface of the user computing device; and
receiving, by a human machine interface of the user computing device, at least one item of data from a selection comprising the carbon footprint value, the aggregate carbon footprint value, the warning message, and at least one carbon footprint reduction action.

8. The method according to claim 1, further comprising: evaluating, by the fleet management system, driver authorization to operate the specific vehicle based on data identifying a specific driver.

9 A system for electronically optimizing carbon usage across a fleet of vehicles, comprising:
a processor; and
memory, the processor being configured to execute instructions stored in memory to perform a method comprising:
receiving a selection of a specific vehicle from a plurality of vehicles in a fleet for use by a driver;
receiving, via a computer network, at least one vehicle performance metric for a trip performed by the driver in the specific vehicle; and
determining a carbon footprint value for the driver performing the trip based at least on chemical composition of a fuel type, and a fuel consumption performance metric for the specific vehicle.

10. The system according to claim 9, wherein the computer network comprises at least one user computing device interactively coupled to a fleet management system, the fleet management system communicatively coupled to a provider of vehicle performance metrics.

11. The method according to claim 10, wherein the provider of vehicle performance metrics receives the vehicle performance metrics from a plurality of sensors substantially in real-time and communicates the metrics to the fleet management system substantially in real-time.

12. The system according to claim 10, further comprising instructions stored in memory to perform a method comprising:
selecting, from a plurality of footprint reduction actions, at least one action to reduce the carbon footprint value of the driver; and
selectively communicating the at least one action to a user computing device operated by the driver.

13. The system according to claim 12, further comprising instructions stored in memory to perform a method comprising:
selecting at least one evaluation feature from a plurality of evaluation features;
generating an aggregate carbon footprint value by aggregating a plurality of the carbon footprint values from a plurality of trips as a function of the selected evaluation feature;
communicating the aggregate carbon footprint value to the fleet management system;
monitoring, by the fleet management system, the aggregate carbon footprint value in comparison to a threshold value; and
communicating a warning message of excess carbon usage to the user computing device in response to the aggregate carbon footprint value exceeding the threshold value.

14. The system according to claim 13, further comprising instructions stored in memory to perform a method comprising:
generating a compilation of a plurality of aggregate carbon footprint values;
transmitting the compilation to the fleet management system for performing resource optimization of fleet vehicles and drivers.

15. The system according to claim 14, further comprising instructions stored in memory to perform a method comprising:
presenting a graphical user interface on a human machine interface of the user computing device; and
receiving, by a human machine interface of the user computing device, at least one item of data from a selection comprising the carbon footprint value, the aggregate carbon footprint value, the warning message, and at least one carbon footprint reduction action.

16. The system according to claim 9, further comprising instructions stored in memory to perform a method comprising:
evaluating, by the fleet management system, driver authorization to operate the specific vehicle based on data identifying a specific driver.

17. A non-transitory computer-readable storage medium having embodied thereon instructions, which, when executed by at least one processor, perform steps of a method, the method comprising:
receiving a selection of a specific vehicle from a plurality of vehicles in a fleet for use by a driver;
receiving, via a computer network, at least one vehicle performance metric for a trip performed by the driver in the specific vehicle; and
determining a carbon footprint value for the driver performing the trip based at least on chemical composition of a fuel type, and a fuel consumption performance metric for the specific vehicle.

18. The storage medium according to claim 17 further comprising instructions, which, when executed by at least one processor, perform steps of a method, the method comprising:
selecting, from a plurality of footprint reduction actions, at least one action to reduce the carbon footprint value of the driver; and
selectively communicating the at least one action to a user computing device operated by the driver.

19. The storage medium according to claim 18 further comprising instructions, which, when executed by at least one processor, perform steps of a method, the method comprising:
selecting at least one evaluation feature from a plurality of evaluation features;
generating an aggregate carbon footprint value by aggregating a plurality of the carbon footprint values from a plurality of trips as a function of the selected evaluation feature;
communicating the aggregate carbon footprint value to the fleet management system;
monitoring, by the fleet management system, the aggregate carbon footprint value in comparison to a threshold value; and
communicating a warning message of excess carbon usage to the user computing device in response to the aggregate carbon footprint value exceeding the threshold value.

20. The storage medium according to claim 19 further comprising instructions, which, when executed by at least one processor, perform steps of a method, the method comprising:
generating a compilation of a plurality of aggregate carbon footprint values;
transmitting the compilation to the fleet management system for performing resource optimization of fleet vehicles and drivers.

21. The method according to claim 20 further comprising instructions, which, when executed by at least one processor, perform steps of a method, the method comprising:
presenting a graphical user interface on a human machine interface of the user computing device; and
receiving, by a human machine interface of the user computing device, at least one item of data from a selection comprising the carbon footprint value, the aggregate carbon footprint value, the warning message, and at least one carbon footprint reduction action.
